(19) United States
(12) Patent Application Publication
(10) Pub. No.: US 2026/0352531 A1
(43) Pub. Date: Nov. 5, 2026

(54) FOURIER TRANSFORM DEVICE AND WIRELESS COMMUNICATION DEVICE

(71) Applicant: Kyoto University, Kyoto (JP)

(72) Inventors: Hiroki TAKEUCHI, Kyoto (JP); Junya SUZUKI, Kyoto (JP); Shunsuke ADACHI, Kyoto (JP)

(21) Appl. No.: 19/705,893

(22) Filed: Jun. 12, 2026

Related U.S. Application Data
(63) Continuation of application No. PCT/JP2024/039790, filed on Nov. 8, 2024.

(30) Foreign Application Priority Data
Dec. 12, 2023 (JP) 2023-209086

(51) Int. Cl. H04L 27/26; G06F 17/14

(52) U.S. Cl. CPC H04L 27/2602; G06F 17/142

(57) ABSTRACT

A Fourier transform device that performs either an N-point fast Fourier transform or an N-point inverse fast Fourier transform includes a rotator and a rotation memory that stores twiddle factors. The rotation memory includes a first rotation memory storing multiple first twiddle factors that correspond to rotational positions resulting from dividing 2π into N1 equal parts, where N1 is an integer equal to 2 to the power of n1, and a second rotation memory storing multiple second twiddle factors that correspond to rotational positions resulting from dividing 2π/N1 into N2 equal parts, N2 being N/N1, where N2 is an integer equal to 2 to the power of n2. The rotator includes a first complex multiplier to which one of the multiple first twiddle factors is selectively set, and a second complex multiplier to which one of the multiple second twiddle factors is selectively set.

### CROSS-REFERENCE TO RELATED APPLICATIONS

The present application is a continuation application of International Application No. PCT/JP2024/039790 filed on Nov. 8, 2024, which claims priority to Japanese Patent Application No. 2023-209086 filed on Dec. 12, 2023. The contents of these applications are incorporated herein by reference in their entirety.

### TECHNICAL FIELD

The present invention relates to a Fourier transform device that performs fast Fourier transforms (including inverse fast Fourier transforms) and to a communication device.

### BACKGROUND ART

Fast Fourier transforms (hereinafter, also referred to as “FFTs”) are conventionally used in various fields. In an effort to implement FFTs in hardware, various studies have been conducted for the purposes of speeding up processing, improving efficiency, reducing memory usage, and so on as described in Mario Garrido, “A Survey on Pipelined FFT Hardware Architectures,” Journal of Signal Processing Systems (2022) 94:1345-1364 (Document 1). As one example for efficiently executing FFTs, an architecture called “Radix-2^{k}” is well known (Mario Garrido and three other authors, “Pipelined Radix-2^{k} Feedforward FFT Architectures,” IEEE TRANS. VLSI SYSTEMS, VOL. 21, NO. 1, pp. 23-32, JANUARY 2013 (Document 2)). Here, “k” in “Radix-2^{k}” denotes an integer greater than or equal to 2. For example, Jung-Yeol OH and another author, “New Radix-2 to the 4th Power Pipeline FFT Processor,” IEICE TRANS. ELECTRON, VOL. E88-C, NO. 8, pp. 1740-1746, AUGUST 2005 (Document 3) proposes a Radix-2⁴ algorithm. Adopting a Radix-2^{k} algorithm simplifies computations of twiddle factors in FFTs. Note that “k” in “Radix-2^{k}” is not related to a variable k in Fourier transforms described later.

Meanwhile, techniques for reducing storage area for twiddle factors in FFTs have also been proposed. For example, Japanese Patent Application Publication No. H5-324697 (Document 4) discloses a technique for reducing memory usage by focusing on a phase shift between cosine and sine functions with respect to twiddle factors and on positive and negative symmetry of these functions and then storing only positive values of trigonometric functions in the memory without duplicating the twiddle factors. Japanese Patent Application Publication No. H4-177461 (Document 5) discloses a technique for achieving a speedup in computation and a reduction in memory capacity required to store data by using fixed-point computations such as integer computations, instead of double-precision floating-point computations, in computations of FFTs.

Incidentally, FFTs use rotation matrices that are known as twiddle factors and that correspond to rotational positions resulting from dividing a unit circle in a complex plane into N equal parts. The twiddle factors are combinations of the values of cosine and sine functions, and a large number of twiddle factors needs to be stored in order to realize high frequency resolutions in FFTs. This consequently requires a storage device with large storage capacity and increases the manufacturing cost of Fourier transform devices. However, there are limits to reducing storage capacity for storing twiddle factors by simply utilizing the symmetry of cosine and sine functions as shown in Document 4.

Reducing the storage capacity for storing twiddle factors is particularly important when FFTs are implemented in devices such as FPGAs (field-programmable gate arrays) that have limited paths available for reading out twiddle factors in terms of hardware. Note that a reduction in storage capacity for storing twiddle factors is also a challenge in inverse fast Fourier transforms (IFFTs).

### SUMMARY OF THE INVENTION

It is an object of the present invention to reduce storage capacity required of a Fourier transform device to store twiddle factors.

Aspect 1 of the present invention is a Fourier transform device that performs either an N-point fast Fourier transform or an N-point inverse fast Fourier transform, where N is 2 to the power of n, and n is an integer greater than or equal to 5. The Fourier transform device includes a rotator that performs a rotation operation, and a rotation memory that stores twiddle factors,

The rotation memory includes a first rotation memory storing a plurality of first twiddle factors that correspond to rotational positions resulting from dividing 2π into N1 equal parts, where N1 is an integer equal to 2 to the power of n1, and n1 is an integer greater than or equal to 3, and a second rotation memory storing a plurality of second twiddle factors that correspond to rotational positions resulting from dividing 2n/N1 into N2 equal parts, N2 being N/N1, where N2 is an integer equal to 2 to the power of n2, and n2 is an integer greater than or equal to 1. The rotator performs a rotation operation that combines a first twiddle factor selected from the plurality of first twiddle factors and a second twiddle factor selected from the plurality of second twiddle factors.

According to the present invention, it is possible to reduce storage capacity required of the Fourier transform device to store twiddle factors.

Aspect 2 of the present invention is the Fourier transform device according to Aspect 1 that further includes a Radix-2^{k} circuit that performs a computation using a Radix-2^{k} algorithm. The rotator is either connected to or included in the Radix-2^{k} circuit.

Aspect 3 of the present invention is the Fourier transform device according to Aspect 2 that further includes a plurality of small Fourier transform circuits aligned in parallel, the plurality of small Fourier transform circuits each being a circuit that performs either a single-input, single-output Fourier transform or a single-input, single-output inverse Fourier transform. The Radix-2^{k} circuit is arranged downstream of the plurality of small Fourier transform circuits, and the Fourier transform device is a multipath delay feedback Fourier transform device in which a plurality of rotators including the rotator are arranged between the plurality of small Fourier transform circuits and the Radix-2^{k} circuit.

Aspect 4 of the present invention is the Fourier transform device according to Aspect 3, in which the number of the plurality of small Fourier transform circuits is P, where P is 2 to the power of p, and p is an integer greater than or equal to 2. The Fourier transform device is a multipath delay feedback Fourier transform device in which (P−1) rotators including the rotator are arranged between the plurality of small Fourier transform circuits and the Radix-2^{k} circuit.

Aspect 5 of the present invention is the Fourier transform device according to Aspect 2 that further includes 16 small Fourier transform circuits aligned in parallel, the 16 small Fourier transform circuits each being a circuit that performs either a single-input, single-output Fourier transform or a single-input, single-output inverse Fourier transform. A Radix-2⁴ circuit serving as the Radix-2^{k} circuit is arranged downstream of the 16 small Fourier transform circuits. The Fourier transform device is a multipath delay feedback Fourier transform device in which 15 rotators including the rotator are arranged between the 16 small Fourier transform circuits and the Radix-2⁴ circuit.

Aspect 6 of the present invention is the Fourier transform device according to Aspect 1 (or according to any one of Aspects 1 to 5). The Fourier transform device receives input of a digital signal resulting from digital conversion of an analog signal with a bandwidth of more than or equal to 4 GHz, and produces an output with a frequency resolution of less than or equal to 100 kHz, or the Fourier transform device receives input of frequency information that includes a frequency resolution of less than or equal to 100 kHz, and produces an output that is an analog signal resulting from analog conversion of a digital signal and having a bandwidth of more than or equal to 4 GHz.

Aspect 7 of the present invention is the Fourier transform device according to Aspect 6, in which the frequency resolution of the output is less than or equal to 50 kHz, or the frequency resolution included in the frequency information that is input is less than or equal to 50 kHz.

Aspect 8 of the present invention is the Fourier transform device according to any one of Aspects 1 to 7. The Fourier transform device performs the fast Fourier transform in a device that performs frequency analysis on a digital signal resulting from conversion of a high-frequency analog signal at a frequency of higher than or equal to 300 MHz and lower than or equal to 300 GHz.

Aspect 9 of the present invention is a wireless communication device that includes either an analog-to-digital converter or a digital-to-analog converter connected to an antenna, and the Fourier transform device according to any one of claims 1 to 7 that either performs a Fourier transform on a digital signal that is output from the analog-to-digital converter, or performs an inverse Fourier transform on digital information to transmit the digital information to the digital-to-analog converter.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 is a diagram showing a schematic configuration of a frequency analysis device that includes a Fourier transform device.

FIG. 2 is a diagram showing an architecture of an FFT circuit.

FIG. 3 is a diagram showing a butterfly operator.

FIG. 4 is a diagram showing a small FFT circuit.

FIG. 5 is a diagram showing a configuration of (first) rotators and rotation memories connected to the rotators.

FIG. 6 is a diagram showing another exemplary architecture of the FFT circuit.

FIG. 7 is a diagram showing yet another exemplary architecture of the FFT circuit.

FIG. 8 is a diagram showing a configuration of a communication system.

FIG. 9 is a diagram showing another example of a configuration of the rotators and the rotation memories connected to the rotators.

### DETAILED DESCRIPTION

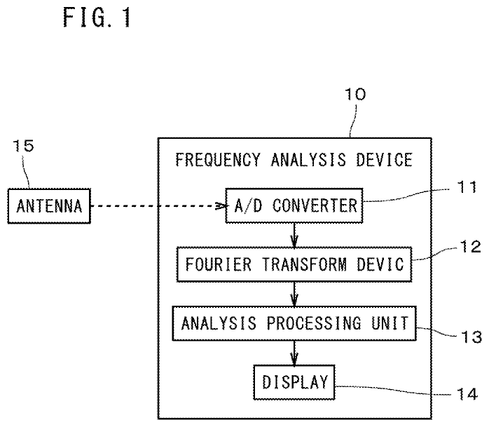

FIG. 1 is a diagram showing a schematic configuration of a frequency analysis device 10 that includes a Fourier transform device 12 according to one embodiment of the present invention. The frequency analysis device 10 includes an A/D (analog-to-digital) converter 11, the Fourier transform device 12, an analysis processing unit 13, and a display 14. The A/D converter 11 is electrically connected to an antenna 15. The antenna 15 may be regarded as part of the frequency analysis device 10. Conversely, the A/D converter 11 may be regarded as being not included in the frequency analysis device 10. A device that inputs a signal to the A/D converter 11 is not limited to the antenna 15, and a high-frequency analog signal such as a noise component generated by a high-frequency signal generating circuit or an electrical circuit may be input to the A/D converter 11. That is, the frequency analysis device 10 may be used for measurements in high-frequency signal (RF) circuits.

The antenna 15 converts electromagnetic waves into electrical analog signals and outputs obtained analog signals to the A/D converter 11. The A/D converter 11 converts an analog signal through high-speed sampling performed at fixed intervals into a digital signal, i.e., a time-series array of numerical values. Note that the frequency band of the analog signal may be shifted toward lower frequencies by using a mixer before the analog signal is input to the A/D converter 11.

The Fourier transform device 12 receives input of an array of numerical values (hereinafter, also referred to as “input data”) from the A/D converter 11, converts the input data into an array of numerical values that indicate amplitudes for each frequency (hereinafter also referred to as “output data”), and outputs the output data. That is, a fast Fourier transform (FFT) is performed on input data that indicates a time-varying value, and the input data is converted into output data that indicates the magnitudes of components in a frequency domain.

The analysis processing unit 13 converts the output data received from the Fourier transform device 12 into information suitable for display on the display 14. For example, output data that is output repeatedly at high speed from the Fourier transform device 12 is averaged for each frequency and output at fixed time intervals. This enables an operator who is observing the display 14 to appropriately grasp the result of analysis in real time.

The frequency analysis device 10 can be used in various applications and is, in particular, suitable for situations that require broadband and continuous measurements. The frequency analysis device 10 is applicable to, for example, frequency measurements in radio astronomical observations, multiplexed readout technology for superconducting detectors, and communication technology. Details of the antenna 15 and the frequency analysis device 10 are configured as appropriate according to their specific application. For example, an antenna designed to receive radio waves from outer space, an antenna for use in wireless communication, or the like is adopted as appropriate as the antenna 15. The frequency analysis device 10 may, of course be used in various other fields of frequency analysis.

As described later, the Fourier transform device 12 in the frequency analysis device 10 is capable of reducing its storage capacity for storing twiddle factors, thereby achieving a reduction in the manufacturing cost of the analysis device. This effect is particularly evident when the Fourier transform device 12 is implemented in hardware. Besides, power consumption is also reduced.

For example, in the field of radio astronomical observations, dark matter observations conducted in outer space requires real-time frequency analysis of radio waves from outer space. Therefore, it is necessary to implement high-speed computations in FFTs as hardware using electric circuits such as FPGAs or ASICs (application-specific integrated circuits). However, in order to perform FFTs at high-speed and with high-frequency resolutions, enormous storage capacity becomes necessary to store twiddle factors, which is impossible to implement in commercially available hardware such as FPGAs. The Fourier transform device 12 described below can significantly reduce the storage capacity required to store twiddle factors while suppressing a decrease in computation speed, and therefore can be implemented in commercially available hardware while reducing circuit scale including memory in the hardware.

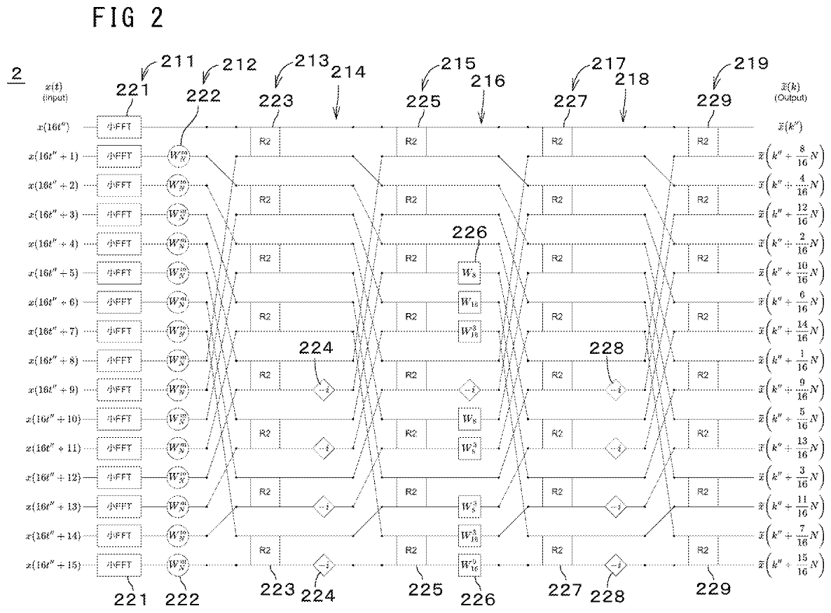

FIG. 2 is a diagram showing an architecture of an FFT circuit 2 in the Fourier transform device 12. In FIG. 2, the left side corresponds to the input side of the FFT circuit 2, and the right side corresponds to the output side. The FFT circuit 2 includes, in order from the input side toward the output side, a small FFT circuit group 211, a first rotator group 212, a first butterfly operator group 213, a second rotator group 214, a second butterfly operator group 215, a third rotator group 216, a third butterfly operator group 217, a fourth rotator group 218, and a fourth butterfly operator group 219. Note that the “group” as used herein refers to a set of one or more identical or similar elements. The small FFT circuit group 211 includes 16 small FFT circuits 221, each performing an FFT operation. As described later, each small FFT circuit 221 is a single-input/output, i.e., a single-input, a single-output FFT circuit.

The first rotator group 212 includes 15 first rotators 222, to each of which a selected twiddle factor can be set as described later. The “rotator” as used herein refers to a circuit that performs a rotation operation of multiplying a rotation matrix. The second rotator group 214 includes four second rotators 224, but rotations by the second rotators 224 are fixed to a 90° rotation operation. In FIG. 2, the rotators that perform a 90° rotation operation are denoted by “−i” (the same applies below). The fourth rotator group 218 is identical to the second rotator group 214 and includes four first rotators 228, each performing a 90° rotation operation. The third rotator group 216 includes nine third rotators 226. These third rotators perform rotation operations using various rotation angles, but the rotation angle at each third rotator 226 is fixed.

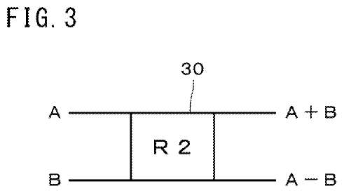

The first butterfly operator group 213 includes eight first butterfly operators 223. The second butterfly operator group 215 includes eight second butterfly operators 225. The third butterfly operator group 217 includes eight third butterfly operators 227. The fourth butterfly operator group 219 includes eight fourth butterfly operators 229. In FIG. 2, the butterfly operators are denoted by “R2” (the same applies below). FIG. 3 is a diagram showing one butterfly operator 30 (corresponding to one of the first to fourth butterfly operators 223, 225, 227, and 229). When receiving input of values A and B, the butterfly operator 30 outputs values (A+B) and (A−B).

Next, computations corresponding to the architecture of the FFT circuit 2 are described. Expression 1 is an equation that represents the N-size discrete Fourier transform, i.e., an equation for performing an N-sample Fourier transform. Here, N is 2 to the power of n, and in the present embodiment, n is an integer greater than or equal to 5. By the Fourier transform, a function x(t) using time t as a variable is converted into a function x-tilde(k) using a frequency k as a variable (hereinafter, x-tilde with a tilde over x is also expressed as “x^{~}”). In other words, time-series data x(t) is converted into spectrum data x^{~}(k) by the Fourie transform.

$$\tilde{x} ( k ) = {\sum }_{t = 0}^{N - 1} {e}^{- 2 π i \frac{kt}{N}} x ( t ) \qquad [ Expression 1 ]$$

Here, the right-hand side represents the sum of equations within Σ when t varies from 0 to (N−1). Letting t=t′+16t″, Expression 1 is divided by the remainder t′ resulting from dividing t by 16 to obtain Expression 2.

$$\tilde{x} ( k ) = {\sum }_{{t}^{′} = 0}^{15} ( {\sum }_{{t}^{″} = 0}^{\frac{N}{16} - 1} {e}^{- 2 π i \frac{k ( {t}^{′} + 16 {t}^{″} )}{N}} x ( {t}^{′} + 16 {t}^{″} ) ) \qquad [ Expression 2 ]$$

Out of two Σ terms in Expression 2, the Σ term on the left side represents the division into 16 parts, while the Σ term on the right side represents the term obtained by extracting the term of the remainder t′. The size of the Σ term on the right side is N/16.

Here, letting k=(N/16)k′+k″, Expression 2 becomes Expression 3. Furthermore, the right-hand side in Expression 3 becomes Expression 4 since e to the power of (−2πi) corresponds to a 2π rotation, i.e., 1, and e to the power of integer multiple of (−2πi) is also 1.

$$\tilde{x} ( \frac{N}{16} {k}^{′} + {k}^{″} ) = {\sum }_{{t}^{′} = 0}^{15} {\sum }_{{t}^{″} = 0}^{\frac{N}{16} - 1} {e}^{- 2 π i \frac{( \frac{N}{16} {k}^{′} + {k}^{″} ) ( {t}^{′} + 16 {t}^{″} )}{N}} x ( {t}^{′} + 16 {t}^{″} ) \qquad [ Expression 3 ]$$

$${{{\sum }_{{t}^{′} = 0}^{15} {e}^{- 2 π i \frac{{k}^{′} {t}^{′}}{16}}}_{⎵}}_{( 4 - 4 )} {{{e}^{- 2 π i \frac{{k}^{″} {t}^{′}}{N}}}_{⎵}}_{( 4 - 3 )} {{{\sum }_{{t}^{″} = 0}^{\frac{N}{16} - 1} {e}^{- 2 π i \frac{{k}^{″} {t}^{″}}{\frac{N}{16}}}}_{⎵}}_{( 4 - 2 )} {{x ( {t}^{′} + 16 {t}^{″} )}_{⎵}}_{( 4 - 1 )} \qquad [ Expression 4 ]$$

In Expression 4, the term x(t′+16t″) on the rightmost-hand side, denoted by (4-1), represents the input value. The Σ term on the left-hand side, denoted by (4-2), represents the N/16-point discrete Fourier transform in which a function of t″ is converted into a function of k″. The next term, i.e., e to the power of (−2πi(k″t′/N)), denoted by (4-3) represents the twiddle factor.

For the Σ term on the leftmost-hand side denoted by (4-4), letting k′=8k′₀+4k′₁+2k′₂+k′₃ where k′₀, k′₁, k′₂, and k′₃ are either 0 or 1 and letting t′=t′₀+2t′₁+4t′₂+8t′₃ where t′₀, t′₁, t′₂, and t′₃ are either 0 or 1, the term denoted by (4-4) in Expression 4 becomes Expression 5. Here, too, the fact that e to the power of integer multiple of (−2πi) is 1 is used. Expression 5 represents the (main) operation part to which the Radix-2⁴ algorithm is applied.

$$[ Expression 5 ]$$

$${{{\sum }_{{t}^{′} = 0}^{15} {e}^{- 2 π i \frac{{k}^{′} {t}^{′}}{16}}}_{⎵}}_{( 4 - 4 )} = {{{\sum }_{{t}_{0}^{′} = 0}^{1} {e}^{- 2 π i \frac{{k}_{0}^{′} {t}_{0}^{′}}{2}}}_{⎵}}_{( 5 - 7 )} {{{e}^{- 2 π i \frac{{k}_{1}^{′} {t}_{0}^{′}}{4}}}_{⎵}}_{( 5 - 6 )} {{{\sum }_{{t}_{1}^{′} = 0}^{1} {e}^{- 2 π i \frac{{k}_{1}^{′} {t}_{1}^{′}}{2}}}_{⎵}}_{( 5 - 5 )} {{{e}^{- 2 π i \frac{( 2 {k}_{2}^{′} + {k}_{3}^{′} ) ( {t}_{0}^{′} + 2 {t}_{1}^{′} )}{16}}}_{⎵}}_{( 5 - 4 )} {{{\sum }_{{t}_{2}^{′} = 0}^{1} {e}^{- 2 π i \frac{{k}_{2}^{′} {t}_{2}^{′}}{2}}}_{⎵}}_{( 5 - 3 )} {{{e}^{- 2 π i \frac{{k}_{3}^{′} {t}_{2}^{′}}{4}}}_{⎵}}_{( 5 - 2 )} {{{\sum }_{{t}_{3}^{′} = 0}^{1} {e}^{- 2 π i \frac{{k}_{3}^{′} {t}_{3}^{′}}{2}}}_{⎵}}_{( 5 - 1 )}$$

Next, the correspondence between the FFT circuit 2 shown in FIG. 2 and Expressions 4 and 5 is described.

The leftmost input (Input) shown in FIG. 2 corresponds to (4-1) in Expression 4. The small FFT circuit group 211 corresponds to (4-2) in Expression 4. That is, each small FFT circuit 221 performs an N/16-point discrete fast Fourier transform to convert the function of t″ into the function of k″.

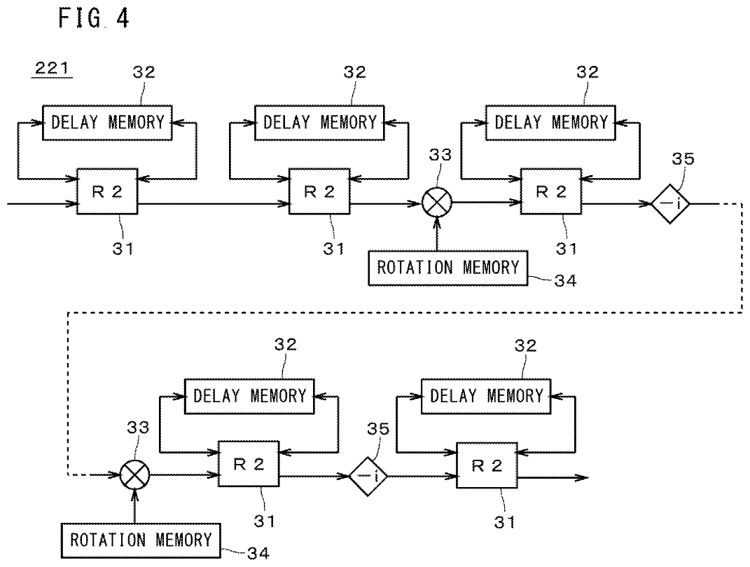

FIG. 4 is a diagram showing one small FFT circuit 221. The small FFT circuit 221 shown in FIG. 4 is a single-input, single-output Fourier transform circuit. Various forms different from that shown in FIG. 4 are available as the small FFT circuit 221. The small FFT circuit 221 shown in FIG. 4 includes multiple butterfly operators 31. Each butterfly operator 31 performs a computation identical to that performed by the butterfly operator 30 shown in FIG. 3. Each butterfly operator 31 is connected to a delay memory 32 so that values that are input to and output from the butterfly operator 31 can be stored as appropriate and output with desired timing. If necessary, a rotator 33 or a rotator 35 that is fixed to a 90° rotation (denoted by “−i”) may be provided between a pair of butterfly operators 31 connected in series. One of the multiple twiddle factors stored in a rotation memory 34 is selected and set to the rotator 33. The rotation memory 34 stores twiddle factors for performing N/16-point FFT operations.

The first rotator group 212 shown in FIG. 2 corresponds to the term denoted by (4-3) in Expression 4, and 2π·(m/N) rotations are expressed as W_{N}^{m}. In each W_{N}^{m}, m is k″t′. A twiddle factor representing W_{N}^{m} is set to each first rotator 222 for each computation.

The first butterfly operator group 213 corresponds to the rightmost Σ term denoted by (5-1) in Expression 5. Each first butterfly operator 223 is connected between the first rotator group 212 and the first butterfly operator group 213 so that the first butterfly operator 223 receives an input in which t′₂, t′₁, and t′₀ are the same value and t′₃ is 0 and an input in which t′₂, t′₁, and t′₀ are the same value and t′₃ is 1. For example, the uppermost first butterfly operator 223 receives input of a value derived from the uppermost small FFT circuit 221 and a value derived from the ninth small FFT circuit 221 from the top. The input from the ninth small FFT circuit differs only in the value of t′₃ from the input from the first small FFT circuit. Through the first butterfly operator group 213, t′₃ is converted into k′₃ (to be more precise, a function using t′₃ as a variable is converted into a function using k′₃ as a variable). The same expression is also used below.

The second rotator group 214 corresponds to the term denoted by (5-2) in Expression 5. Here, since k′₃t′₂ is either 0 or 1, either a 0 rotation operation (i.e., no rotation) or a 2π/4 (90°) rotation operation is performed in (at the position of) the second rotator group 214. The second rotator group 214 includes only the four second rotators 224, and each second rotator 224 performs a fixed operation.

The second butterfly operator group 215 corresponds to the second Σ term denoted by (5-3) in Expression 5. Each second butterfly operator 225 is connected between the second rotator group 214 and the second butterfly operator group 215 so that the second butterfly operator 225 receives an input in which k′₃, t′₁, and t′₀ are the same value and t′₂ is 0 and an input in which t′₃, t′₁, and t′₀ are the same value and t′₂ is 1. Through the second butterfly operator group 215, t′₂ is converted into k′₂.

The third rotator group 216 corresponds to the term denoted by (5-4) in Expression 5. Here, since (2k′₂+k′₃)·(t′₀+2t′₁)/16 is one of 0, 1, 2, 3, 4, 6, and 9, a 0 rotation operation (i.e., no rotation), a 2π/16 (=22.5°) rotation operation, a 2π/8 (=45°) rotation operation, a 2π·3/16 (=67.5°) rotation operation, a 2π/4 (=90°) rotation operation, a 2π·3/8 (=135°) rotation operation, or a 2π·9/16 (=202.5°) rotation operation is performed in (at the position of) the third rotator group 216. The third rotator group 216 includes only the nine third rotators 226, and each third rotator 226 performs a fixed operation.

The third butterfly operator group 217 corresponds to the third Σ term from the right side, denoted by (5-5) in Expression 5. Each third butterfly operator 227 is connected between the third rotator group 216 and the third butterfly operator group 217 so that the third butterfly operator 227 receives an input in which k′₃, k′₂, and t′₀ are the same value and t′₁ is 0 and an input in which k′₃, k′₂, and t′₀ are the same value and t′₁ is 1. Through the third butterfly operator group 217, t′₁ is converted into k′₁.

The fourth rotator group 218 corresponds to the term denoted by (5-6) in Expression 5. Here, since k′₁t′₀ is either 0 or 1, either a 0 rotation operation (i.e., no rotation) or a 2π/4 (=90°) rotation operation is performed in (at the position of) the fourth rotator group 218. The fourth rotator group 218 includes only the four fourth rotators 228, and each fourth rotator 228 performs a fixed operation.

The fourth butterfly operator group 219 corresponds to the fourth Σ term from the right side, denoted by (5-7) in Expression 5. Each fourth butterfly operator 229 is connected between the fourth rotator group 218 and the fourth butterfly operator group 219 so that the fourth butterfly operator 229 receives an input in which k′₃, k′₂, and k′₁ are the same value and t′₀ is 0 and an input in which k′₃, k′₂, and k′₁ are the same value and t′₀ is 1. Through the fourth butterfly operator group 219, t′₀ is converted into k′₀.

Through the processing described above, after inputs x(16t″), x(16t″+1), x(16t″+2), . . . , and x(16t″+15) are input in parallel in sequence, x^{~}(k″), x^{~}(k″+(1/16)N), x^{~}(k″+(2/16)N), . . . , and x^{~}(k″+(15/16)N) are output in parallel in sequence (however, the order of the outputs is as shown on the right side (Output) in FIG. 2).

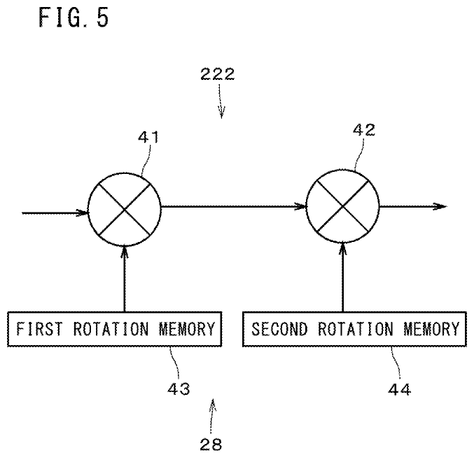

Next, the first rotator group 212 is described. FIG. 5 is a diagram showing a configuration of a first rotator 222 and a rotation memory 28 connected to the first rotator. The rotation memory 28 stores twiddle factors. The rotation memory 28 is shared among the first rotators 222 in the first rotator group 212. That is, the single rotation memory 28 (to be more precise, a set of a first complex multiplier 41 and a second complex multiplier 42 described below) is provided for the first rotator group 212. The first rotators 222 each include the first complex multiplier 41 and the second complex multiplier 42. The first complex multiplier 41 and the second complex multiplier 42 are connected in series. The first complex multiplier 41 and the second complex multiplier 42 are each an operator that multiplies rotation matrices, and each serve as a rotator. That is, the first rotator 222 includes two rotators connected in series. The rotation memory 28 includes a first rotation memory 43 and a second rotation memory 44. The first rotation memory 43 is connected to the first complex multiplier 41. The second rotation memory 44 is connected to the second complex multiplier 42.

The first rotation memory 43 stores N1 first twiddle factors that correspond to rotational positions resulting from dividing 2π into N1 equal parts (which are rotational positions on a unit circle centered at the origin and can also be expressed as rotation angles or the amounts of rotation from a 0° position). Here, N1 is an integer equal to 2 to the power of n1, and n1 is an integer greater than or equal to 3. The “twiddle factors that correspond to rotational positions” refer to twiddle factors that each cause a rotation with a rotation angle that ranges from the 0° position on a unit circle in a complex plane to a rotational position of interest. Meanwhile, the second rotation memory 44 stores N2 second twiddle factors that correspond to rotational positions resulting from dividing 2π/N1 into N2 equal parts, N2 being N/N1 (i.e., N=N1·N2). Here, N2 is an integer equal to 2 to the power of n2, and n2 is an integer greater than or equal to 1, where n is equal to n1+n2 and is greater than or equal to 5.

In other words, the first rotation memory 43 stores the first twiddle factors that each cause a rotation with a rotation angle of (2π/N1)·a, where a is an integer satisfying 0≤a<N1, while the second rotation memory 44 stores the second twiddle factors that each cause a rotation with a rotation angle of (2π/N)·b, where b is an integer satisfying 0≤b<N2. In this way, the second twiddle factors correspond to precise rotation angles that are interpolated in coarse rotational positions corresponding to the multiple first twiddle factors. Furthermore, one of the multiple first twiddle factors is selectively set to the first complex multiplier 41, and one of the multiple second twiddle factors is selectively set to the second complex multiplier 42. Since the first complex multiplier 41 and the second complex multiplier 42 are connected in series, rotation matrices, which are the first and second twiddle factors, are multiplied with each other, and a rotation operation is performed using a rotation angle obtained by adding the rotation angles indicated by both of the twiddle factors.

In the actually implemented FFT circuit 2, N is 2 to the 17th power (2¹⁷), N is 2 to the 10th power (2¹⁰), and N2 is 2 to the 7th power (2⁷). That is, the first rotation memory 43 (substantially) stores 2¹⁰ complex numbers which are 2¹¹ real numbers. The second rotation memory 44 stores 2⁷ complex numbers which are 2⁸ real numbers. However, in practice, the number of complex numbers stored in the first rotation memory 43 can be reduced to one-fourth by virtue of symmetry under every π/2 rotation, and the number of real numbers to be stored can further be reduced to one-half, based on the symmetry of sine and cosine functions. That is, the number of real numbers required of the first rotation memory 43 to store the first twiddle factors is 2¹⁰×2/8 (=2⁸).

If the first rotator 222 is implemented as a single complex operator (this case is hereinafter referred to as the “comparative example”), the number of real numbers required to store the twiddle factors is 2¹⁵ (=2¹⁷·2/8). However, in the case of the first rotator 222 shown in FIG. 5, the number of real numbers to be stored in the first rotation memory 43 and the second rotation memory 44 is 2⁹ (=2⁸+2⁸), which is 1/2⁶ as compared with the number of real numbers to be stored in the comparative example.

In the case of the small FFT circuits 221 as well, if each small FFT circuit 221 is constructed as a single-input, single-output circuit that applies a Radix-2^{k} algorithm (hereinafter, also simply referred to as “Radix-2^{k}”), the number of rotators that apply N/16 twiddle factors can be reduced to one. Since such rotators are present in parallel within the 16 small FFT circuits 221 and access, with the same timing, the rotation memory that stores twiddle factors to be set to these rotators, the multiple rotators are allowed to share the rotation memory. By applying Radix-2^{k}, the number of twiddle factors to be set to the other rotators in each small FFT circuit 221 can be reduced to, for example, N/64 or less, although it depends on the method of implementation in hardware. In the small FFT circuit group 211 as a whole, the number of twiddle factors (i.e., complex numbers) required to be stored can be reduced to a value in the range of N/8 to N/16. As described previously, the number of real numbers to be stored actually is one-fourth of the number of complex numbers, and when N is 2¹⁷, the number of real numbers to be stored is in the range of 2¹² to 2¹¹.

On the other hand, in the case where each first rotator 222 is divided into the first complex multiplier 41 and the second complex multiplier 42, the number of real numbers to be stored in the rotation memory 28 is reduced from 2¹⁵ to 2⁹ when N is 2¹⁷. Therefore, even in the FFT circuit 2 as a whole that takes the small FFT circuit group 211 into account, the configuration shown in FIG. 5 brings about a high effect of reducing storage capacity.

Next, considering an increase in the amount of computations, although the first rotators 222 according to the comparative example each perform a single multiplication (to be more precise, a multiplication of rotation matrices using real numbers as their elements; the same applies below), the first rotator 222 shown in FIG. 5 performs two multiplications. In the small FFT circuits 221, when N=2¹⁷, N/16 is 2¹³. When the number of rotators 33 shown in FIG. 4 is 6, the small FFT circuits 221 each perform six multiplications. The 90° rotators 35 only swap the sign of the data and perform no multiplications. Moreover, downstream of the first rotator group 212 shown in FIG. 2, only the third rotator group 216 performs real-number multiplications. Therefore, although the number of multiplications is 8 when the first rotators 222 are each configured as a single complex multiplier, the number of multiplications becomes 9 when the first rotators 22 are each configured by the first complex multiplier 41 and the second complex multiplier 42. In this case, the amount of multiplications increases by only about 1.1 times.

In this way, the FFT circuit 2 can significantly reduce the storage capacity required to store twiddle factors while suppressing an increase in the amount of computations. Besides, this makes it possible to implement the FFT circuit 2 at low cost in commercially available hardware such as FPGAs.

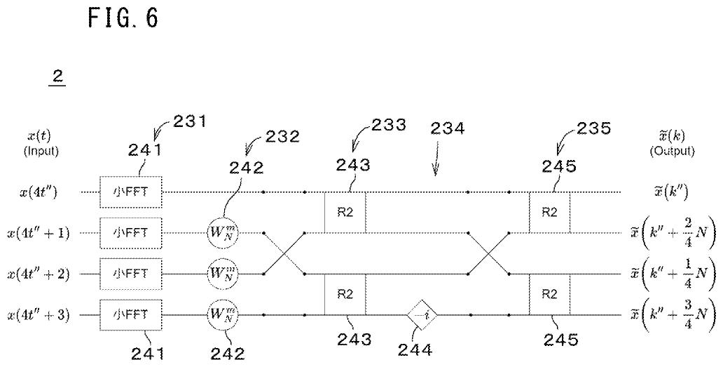

Next, another exemplary architecture of the FFT circuit 2 is described with reference to FIG. 6. The FFT circuit 2 shown in FIG. 6 includes, in order from the input side toward the output side, a small FFT circuit group 231, a first rotator group 232, a first butterfly operator group 233, a second rotator group 234, and a second butterfly operator group 235. The small FFT circuit group 231 includes four small FFT circuits 241, each performing an FFT operation. Each small FFT circuit 241 is a single-input, single-output Fourier transform circuit.

The first rotator group 232 includes three rotators 242, to each of which a selected twiddle factor can be set as described later. The second rotator group 234 includes a single second rotator 244, but a rotation by the second rotator 244 is fixed to a 90° rotation operation. The first butterfly operator group 233 includes two first butterfly operators 243. The second butterfly operator group 235 includes two second butterfly operators 245.

Next, computations corresponding to the architecture of the FFT circuit 2 shown in FIG. 6 are described. Expression 6 represents the N-size discrete Fourier transform and corresponds to the conversion part in Expression 1. Here, N is 2 to the power of n, and in the present embodiment, n is an integer greater than or equal to 5. By the Fourier transform, a function x(t) using time t as a variable is converted into a function x^{~}(k) using a frequency k as a variable (see (Input) on the left side and (Output) on the right side in FIG. 6).

$${\sum }_{t = 0}^{N - 1} {e}^{- 2 π i \frac{kt}{N}} \qquad [ Expression 6 ]$$

Here, letting k=(N/4)k′+k″ and t=t′+4t″, the N-size discrete Fourier transform is divided into an (N/4)-size discrete Fourier transform and a 4-size discrete Fourier transform to obtain Expression 7.

$${{{\sum }_{{t}^{′} = 0}^{3} {e}^{- 2 π i \frac{{k}^{′} {t}^{′}}{4}}}_{⎵}}_{( 7 - 3 )} {{{e}^{- 2 π i \frac{{k}^{″} {t}^{′}}{N}}}_{⎵}}_{( 7 - 2 )} {{{\sum }_{{t}^{″} = 0}^{N / 4 - 1} {e}^{- 2 π i \frac{{k}^{″} {t}^{″}}{N / 4}}}_{⎵}}_{( 7 - 1 )} \qquad [ Expression 7 ]$$

In Expression 7, the Σ term on the left-hand side, denoted by (7-3), represents the division into four parts, while the Σ term on the right-hand side, denoted by (7-1), represents the N/4-point discrete Fourier transform in which the function of t″ is converted into the function of k″. The term denoted by (7-2), i.e., e to the power of (−2πi(k″t′/N)), represents the twiddle factor.

For the Σ term on the leftmost side denoted by (7-3), letting k′=2k′₀+k′₁ where k′₀ and k′₁ are either 0 or 1 and letting t′=t′₀+2t′₁ where t′₀ and t′₁ are either 0 or 1, the term denoted by (7-3) in Expression 7 becomes Expression 8. Expression 8 represents the (main) operation part to which Radix-2² is applied.

$${{{\sum }_{{t}_{0}^{′} = 0}^{1} {e}^{- 2 π i \frac{{k}_{0}^{′} {t}_{0}^{′}}{2}}}_{⎵}}_{( 8 - 3 )} {{{e}^{- 2 π i \frac{{k}_{1}^{′} {t}_{0}^{′}}{4}}}_{⎵}}_{( 8 - 2 )} {{{\sum }_{{t}_{1}^{′} = 0}^{1} {e}^{- 2 π i \frac{{k}_{1}^{′} {t}_{1}^{′}}{2}}}_{⎵}}_{( 8 - 1 )} \qquad [ Expression 8 ]$$

Next, the correspondence of the FFT circuit 2 shown in FIG. 6 and Expressions 7 and 8 is described.

The leftmost input shown in FIG. 6 is x(t), i.e., x(4t″+t′). The small FFT circuit group 231 corresponds to the term denoted by (7-1) in Expression 7. That is, each small FFT circuit 241 performs an N/4-point discrete fast Fourier transform in which the function of t″ is converted into the function of k″. Various architectures are available as a specific architecture of the single-input, single-output small FFT circuits 241.

The first rotator group 232 corresponds to the term denoted by (7-2) in Expression 7. In each W_{N}^{m}, m is k″t′. The twiddle factor W_{N}^{m} is set to each first rotator 242 for each computation.

The first butterfly operator group 233 corresponds to the rightmost Σ term denoted by (8-1) in Expression 8. The first butterfly operator group 233 converts t′₁ into k′₁. The second rotator group 234 corresponds to the term denoted by (8-2) in Expression 8. Here, since k′₁t′₀ is either 0 or 1, either a 0 rotation operation (i.e., no rotation) or a 2πi/4 (=90°) rotation operation is performed in (at the position of) the second rotator group 234. As described previously, the second rotator group 234 includes only a single second rotator 244.

The second butterfly operator group 235 corresponds to the rightmost Σ term denoted by (8-3) in Expression 8. The second butterfly operator group 235 converts t′₀ into k′₀.

Through the processing described above, after inputs x(4t″), x(4t″+1), x(4t″+2), and x(4t″+3) are input in parallel in sequence, x^{~}(k″), x^{~}(k″+(1/4)N), x^{~}(k″+(2/4) N), and x^{~}(k″+(3/4)N) are output in parallel in sequence (however, the order of the outputs is as shown in FIG. 6).

Each first rotator 242 shown in FIG. 6 also adopts the configuration shown in FIG. 5. That is, the first rotators 242 each include the first complex multiplier 41 and the second complex multiplier 42 and each serve as a rotator. The first complex multiplier 41 and the second complex multiplier 42 are connected in series. The first complex multiplier 41 is connected to the first rotation memory 43, and the second complex multiplier 42 is connected to the second rotation memory 44. The first rotation memory 43 stores N1 first twiddle factors that correspond to rotational positions resulting from dividing 2π into N1 equal parts, where N1 is an integer equal to 2 to the power of n1, and n1 is an integer greater than or equal to 3. Meanwhile, the second rotation memory 44 stores N2 second twiddle factors that correspond to rotational positions resulting from dividing 2π/N1 into N2 equal parts, N2 being N/N1 (i.e., N=N1 N2), where N2 is an integer equal to 2 to the power of n2, and n2 is an integer greater than or equal to 1. Note that n is equal to n1+n2 and is greater than or equal to 5. One of the multiple first twiddle factors is selectively set to the first complex multiplier 41, and one of the multiple second twiddle factors is selectively set to the second complex multiplier 42.

By storing each twiddle factor, which is set to each first rotator 242, separately in the first rotation memory 43 which stores the first twiddle factors corresponding to coarse rotational positions and in the second rotation memory 44 which stores the second twiddle factors corresponding to rotation angles that are interpolated in the coarse rotational positions, it is possible to significantly reduce the storage capacity required to store twiddle factors. That is, for example, when N=2¹⁷, as in the case shown in FIG. 2, the numbers of real numbers to be stored in the first rotation memory 43 and the second rotation memory 44 are reduced to 1/2⁶, as compared with the case where the twiddle factors are not stored separately as coarse rotational positions and interpolation rotation angles.

Note that if each small FFT circuit 241 is constructed as a single-input, single-output circuit that applies Radix-2^{k}, the number of rotators that apply N/4 twiddle factors can be reduced to one. Since such rotators are present in parallel within the four small FFT circuits 221, these rotators are allowed to share the rotation memory that stores twiddle factors to be set to the rotators. In the case where the small FFT circuits 241 also adopt Radix-2^{k}, the storage capacity required of the small FFT circuit group 231 to store rotators is reduced, resulting in a decrease in the storage capacity required of the FFT circuit 2 as a whole. This increases the rate of reduction in the storage capacity required of the FFT circuit 2 as a whole when the configuration shown in FIG. 5 is adopted.

Moreover, if rotators that apply N/4 twiddle factors are configured as shown in FIG. 5 within the small FFT circuits 241, it is possible to further reduce the required storage capacity.

Next, considering an increase in the amount of computations, when N=2¹⁷, N/4 is 2¹⁵ in the small FFT circuits 241. When the number of rotators 33 shown in FIG. 4 is 7, the small FFT circuits 241 each perform seven multiplications. Note that the 90° rotators 35 only swap the sign of the data and therefore perform no multiplications. Moreover, downstream of the first rotator group 232 shown in FIG. 6, multiplications are not performed substantially. Therefore, although the number of multiplications is 8 when the first rotators 242 are each configured as a single complex multiplier, the number of multiplications becomes 9 when the first rotators 242 are each configured by the first complex multiplier 41 and the second complex multiplier 42. In this case, the amount of computations increases by only about 1.1 times. Even if a rotator that applies a maximum number of twiddle factors is configured as shown in FIG. 5 within each small FFT circuit 241, the amount of computations increases by only 1.25 times.

In this way, the FFT circuit 2 shown in FIG. 6 can also significantly reduce the storage capacity required to store twiddle factors while suppressing an increase in the amount of computations. This makes it possible to implement the FFT circuit 2 at low cost in commercially available hardware such as FPGAs.

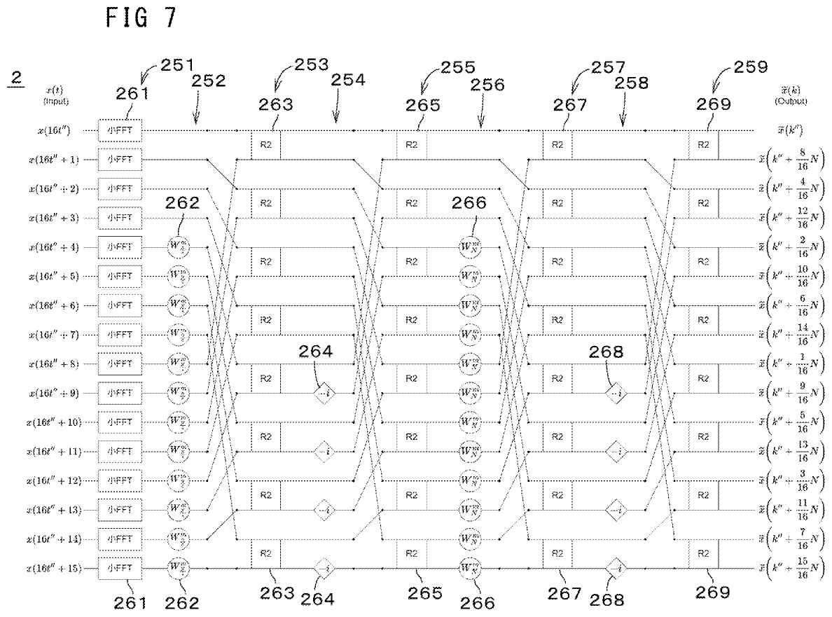

Next, yet another exemplary architecture of the FFT circuit 2 is described with reference to FIG. 7. The FFT circuit 2 shown in FIG. 7 includes, in order from the input side toward the output side, a small FFT circuit group 251, a first rotator group 252, a first butterfly operator group 253, a second rotator group 254, a second butterfly operator group 255, a third rotator group 256, a third butterfly operator group 257, a fourth rotator group 258, and a fourth butterfly operator group 259. The small FFT circuit group 251 includes 16 small FFT circuits 261, each performing an FFT operation. Each small FFT circuit 261 is a single-input, single-output Fourier transform circuit.

The first rotator group 252 includes 12 first rotators 262, to each of which a selected twiddle factor can be set. The second rotator group 254 includes four second rotators 264, but rotations by the second rotators 264 are fixed to a 90° rotation operation. The third rotator group 256 includes 12 third rotators 266, to each of which a selected twiddle factor can be set. The fourth rotator group 258 includes four fourth rotators 268, but rotations by the fourth rotators 268 are fixed to a 90° rotation operation.

The first butterfly operator group 253 includes eight first butterfly operators 263. The second butterfly operator group 255 includes eight second butterfly operators 265. The third butterfly operator group 257 includes eight third butterfly operators 267. The fourth butterfly operator group 259 includes eight fourth butterfly operators 269.

Next, computations corresponding to the architecture of the FFT circuit 2 shown in FIG. 7 are described. First, letting k=(N/16)k′+k″ and t=t′+16″, further letting k′=8k′₀+4k′₁+2k′₂+k′₃ where k′₀, k′₁, k′₂, and k′₃ are either 0 or 1, and yet further letting t′=t′₀+2t′₁+4t′₂+8t′₃ where t′₀, t′₁, t′₂, and t′₃ are either 0 or 1, the N-size discrete Fourier transform expressed by Expression 6 is divided into an (N/16)-size discrete Fourier transform and a 4-size discrete Fourier transform to obtain Expression 9.

$$[ Expression 9 ]$$

$${{{\sum }_{{t}^{′} = 0}^{1} {e}^{- 2 π i \frac{( 2 {k}_{0}^{′} + {k}_{1}^{′} ) ( {t}_{0}^{′} + 2 {t}_{1}^{′} )}{4}}}_{⎵}}_{( 9 - 3 )} {{{e}^{- 2 π i \frac{( N / 16 ( 2 {k}_{2}^{′} + {k}_{3}^{′} ) + {k}^{″} ( {t}_{0}^{′} + 2 {t}_{1}^{′} )}{4}}}_{⎵}}_{( 9 - 2 )} {{{\sum }_{{t}_{2}^{′} , {t}_{3}^{′} , {t}^{″}} {e}^{- 2 π i \frac{( N / 16 ( 2 {k}_{2}^{′} + {k}_{3}^{′} ) ( {t}_{2}^{′} + 2 {t}_{3}^{′} + 4 {t}^{″} )}{N / 4}}}_{⎵}}_{( 9 - 1 )}$$

In Expression 9, the Σ term on the left-hand side, denoted by (9-3), represents the division into four parts, and the Σ term on the right-hand side, denoted by (9-1), represents the N/4-point discrete Fourier transform. The power of e denoted by (9-2) represents the twiddle factor.

The Σ term on the rightmost side, denoted by (9-1) is further divided into an (N/16)-size discrete Fourier transform and a 4-size discrete Fourier transform to obtain Expression 10. In Expression 10, the term on the rightmost side, denoted by (10-1), represents the N/16-point discrete Fourier transform. The term denoted by (10-2) represents the twiddle factor. The terms denoted by (10-3) to (10-5) represent the (main) operation part to which Radix-2² is applied.

$$[ Expression 10 ]$$

$${{{\sum }_{{t}_{2}^{′} = 0}^{1} {e}^{- 2 π i \frac{{k}_{2}^{′} {t}_{2}^{′}}{4}}}_{⎵}}_{( 10 - 5 )} {{{e}^{- 2 π i \frac{{k}_{3}^{′} {t}_{2}^{′}}{4}}}_{⎵}}_{( 10 - 4 )} {{{\sum }_{{t}_{3}^{′} = 0}^{1} {e}^{- 2 π i \frac{{k}_{3}^{′} {t}_{3}^{′}}{2}}}_{⎵}}_{( 10 - 3 )} {{{e}^{- 2 π i \frac{{k}^{″} ( {t}_{2}^{′} + 2 {t}_{3}^{′} )}{N / 4}}}_{⎵}}_{( 10 - 2 )} {{{\sum }_{{t}^{″} = 0}^{N / 16 - 1} {e}^{- 2 π i \frac{{k}^{″} {t}^{″}}{N / 16}}}_{⎵}}_{( 10 - 1 )}$$

Meanwhile, the term denoted by (9-3) in Expression 9 can be transformed into Expression 11, which is the same as Expression 8. Expression 11 represents the (main) operation part to which Radix-2² is applied.

$${{{\sum }_{{t}_{0}^{′} = 0}^{1} {e}^{- 2 π i \frac{{k}_{0}^{′} {t}_{0}^{′}}{2}}}_{⎵}}_{( 11 - 3 )} {{{e}^{- 2 π i \frac{{k}_{1}^{′} {t}_{0}^{′}}{4}}}_{⎵}}_{( 11 - 2 )} {{{\sum }_{{t}_{1}^{′} = 0}^{1} {e}^{- 2 π i \frac{{k}_{1}^{′} {t}_{1}^{′}}{2}}}_{⎵}}_{( 11 - 1 )} \qquad [ Expression 11 ]$$

Next, the correspondence of the FFT circuit 2 shown in FIG. 7 and Expressions 9 to 11 is described.

The leftmost input shown in FIG. 7 is x(t), i.e., x(16t″+t′). The small FFT circuit group 251 corresponds to (10-1) in Expression 10. That is, each small FFT circuit 261 performs an N/16-point discrete fast Fourier transform in which the function of t″ is converted into the function of k″. Various architectures are available as a specific architecture of the small FFT circuits 261.

The first rotator group 252 corresponds to the term denoted by (10-2) in Expression 10. In each W_{N/4}^{m}, m is k″(t′₂+2t′₃). A twiddle factor representing W_{N/4}^{m} is set to each first rotator 262 for each computation. Therefore, the rotation memory connected to the first rotators 262 stores information that is required to set N/4 twiddle factors corresponding to 2π/(N/4)-point rotations to the first rotators 262.

The first butterfly operator group 253 corresponds to the Σ term denoted by (10-3) in Expression 10. The first butterfly operator group 253 converts t′₃ into k′₃. The second rotator group 254 corresponds to the term denoted by (10-4) in Expression 10. Here, since k′₃t′₂ is either 0 or 1, either a 0 rotation operation (i.e., no rotation) or a 2πi/4 (=90°) rotation operation is performed in (at the position of) the second rotator group 254. The second rotator group 254 includes only the four second rotators 264. The second butterfly operator group 255 corresponds to the rightmost Σ term denoted by (10-5) in Expression 10. The second butterfly operator group 255 converts t′₂ into k′₂.

The third rotator group 256 corresponds to the term denoted by (9-2) in Expression 9. A twiddle factor representing W_{N}^{m} is set to each third rotator 266 for each computation.

The third butterfly operator group 257 corresponds to the Σ term denoted by (11-1) in Expression 11. The third butterfly operator group 257 converts t′₁ into k′₁. The fourth rotator group 258 corresponds to the term denoted by (11-2) in Expression 11. Here, since k′₁t′₀ is either 0 or 1, either a 0 rotation operation (i.e., no rotation) or a 2πi/4 (=90°) rotation operation is performed in (at the position of) the third rotator group 258. The third rotator group 258 includes only the four third rotators 268. The fourth butterfly operator group 259 corresponds to the rightmost Σ term denoted by (11-3) in Expression 11. The fourth butterfly operator group 259 converts t′₀ into k′₀.

Through the processing described above, after inputs x(16t″), x(16t″+1), x(16t″+2), . . . , and x(16t″+15) are input in parallel in sequence, x^{~}(k″), x^{~}(k″+(1/16)N), x^{~}(k″+(2/16)N), . . . , and x^{~}(k″+(15/16)N) are output in parallel in sequence (however, the order of the outputs is as shown in FIG. 7) as in the case shown in FIG. 2.

The third rotators 266 shown in FIG. 7 also adopt the configuration shown in FIG. 5. That is, the third rotators 266 each include the first complex multiplier 41 and the second complex multiplier 42 and each serve as a rotator. The first complex multiplier 41 and the second complex multiplier 42 are connected in series. The first complex multiplier 41 is connected to the first rotation memory 43, and the second complex multiplier 42 is connected to the second rotation memory 44. The first rotation memory 43 stores N1 first twiddle factors that correspond to rotational positions resulting from dividing 2π into N1 equal parts, where N1 is an integer equal to 2 to the power of n1, and n1 is an integer greater than or equal to 3. Meanwhile, the second rotation memory 44 stores N2 second twiddle factors that correspond to rotational positions resulting from dividing 2π/N1 into N2 equal parts, N2 being N/N1 (i.e., N=N1·N2), where N2 is an integer equal to 2 to the power of n2, and n2 is an integer greater than or equal to 1. Note that n is equal to n1+n2 and is greater than or equal to 5. One of the multiple first twiddle factors is selectively set to the first complex multiplier 41, and one of the multiple second twiddle factors is selectively set to the second complex multiplier 42.

By storing each twiddle factor, which is set to each third rotator 266, separately in the first rotation memory 43 which stores the first twiddle factors corresponding to coarse rotational positions and in the second rotation memory 44 which stores the second twiddle factors corresponding to rotation angles that are interpolated in the coarse rotational positions, it is possible to significantly reduce the storage capacity required to store twiddle factors as in the case shown in FIG. 2. In particular, in the case where the small FFT circuits 261 also adopt Radix-2^{k}, the storage capacity required of the small FFT circuit group 251 to store rotators is reduced, resulting in a decrease in the storage capacity of the FFT circuit 2 as a whole. This increases the rate of reduction in the storage capacity required of the FFT circuit 2 as a whole when the configuration shown in FIG. 5 is adopted. Besides, as in the case shown in FIG. 2, even adopting the configuration shown in FIG. 5 does not so much increase the amount of computations.

In the case of the example shown in FIG. 7, each first rotator 262 may also adopt the configuration shown in FIG. 5. This reduces the capacity required of the first and third rotator groups 252 and 256 to store twiddle factors.

In this way, by adopting the rotators with the configuration shown in FIG. 5, the FFT circuit 2 shown in FIG. 7 can also significantly reduce the storage capacity required to store twiddle factors while suppressing an increase in the amount of computations. This further allows the FFT circuit 2 to be implemented at low cost in commercially available hardware such as FPGAs.

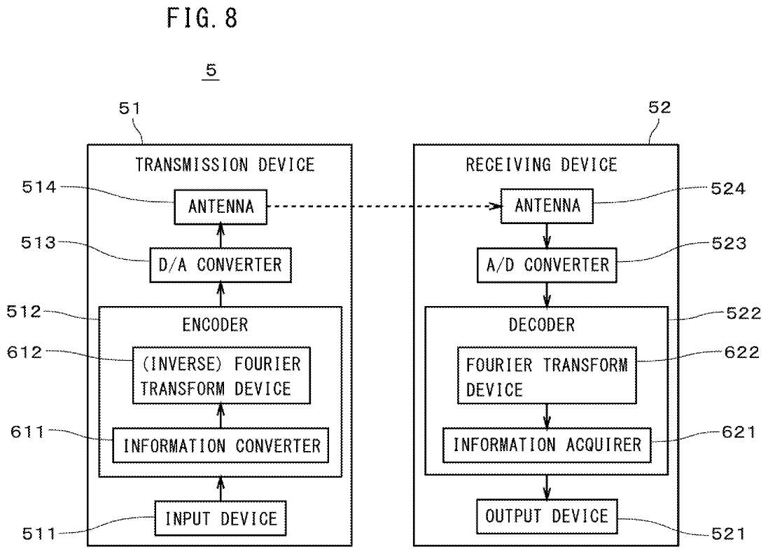

FIG. 8 is a diagram showing a configuration of a communication system 5 including a Fourier transform device that includes any of the FFT circuits 2 shown in FIGS. 2, 6, and 7. The communication system 5 shown in FIG. 8 includes a transmission device 51 that transmits information via electromagnetic waves, and a receiving device 52 that receives electromagnetic waves to acquire information. The transmission device 51 and the receiving device 52 are both wireless communication devices.

The transmission device 51 includes an input device 511, an encoder 512, a D/A (digital-to-analog) converter 513, and an antenna 514. The encoder 512 includes an information converter 611 and an inverse Fourier transform device 612. The input device 511 accepts input of information from an information source. The encoder 512 encodes information and transfers the encoded information to the D/A converter 513. The D/A converter 513 converts the encoded information into an analog signal. The antenna 514 is connected to the D/A converter 513. The antenna 514 converts an analog signal received from the D/A converter 513 into an electromagnetic wave and transfers the electromagnetic wave.

The information converter 611 of the encoder 512 converts information received from the input device 511 into a format suitable for inverse Fourier transforms. For example, in the case where OFDM (orthogonal frequency division multiplexing) is adopted as a communication mode, the information converter 611 maps information bitstreams in a complex plane. Then, the inverse Fourier transform device 612 subjects the mapped digital information to inverse Fourier transforms and transfers obtained information to the D/A converter 513. That is, the inverse Fourier transform device 612 performs encoding by converting the mapped information into information that uses time as a parameter.

Note that the inverse Fourier transform device 612 uses a circuit that inverts the signs of twiddle factors used in the FFT circuit 2 described above as examples. Therefore, in the description of the present embodiment, the inverse Fourier transform device is regarded as one type of the Fourier transform device and is shown as “(INVERSE) FOURIER TRANSFORM DEVICE 612” in FIG. 8. The Fourier transform device, which includes any of the FFT circuits 2 shown in FIGS. 2, 6, and 7, can be used as a Fourier transform device that performs N-point fast Fourier transforms, and can also be used as a Fourier transform device that performs N-point inverse fast Fourier transforms.

The receiving device 52 includes an output device 521, a decoder 522, an A/D (analog-to-digital) converter 523, and an antenna 524. The decoder 522 includes an information acquirer 621 and a Fourier transform device 622. The antenna 524 is connected to the A/D converter 523. The antenna 524 receives an electromagnetic wave from the transmission device 51 and guides an electrical analog signal to the A/D converter 523. The A/D converter 523 converts an analog signal into a digital signal. That is, the A/D converter 523 performs sampling on the analog signal. The decoder 522 decodes a digital signal to acquire information. The output device 521 outputs information received from the decoder 522 to a desired device.

The Fourier transform device 622 of the decoder 522 subjects a digital signal output from the A/D converter 523 to a Fourier transform to convert the digital signal into information in a complex plane, which represents for example multiple frequencies and their amplitudes. The information acquirer 621 converts information received from the Fourier transform device 622 into a format suitable for output. As the Fourier transform device 622, the FFT circuit 2 described above as examples is used. Of course, the inverse Fourier transform device 612 and the Fourier transform device 622 may also adopt any of various other architectures as long as their architectures include the first complex multiplier 41, the second complex multiplier 42, the first rotation memory 43, and the second rotation memory 44 as shown in FIG. 5 and achieve a reduction in storage capacity required to store twiddle factors. This allows a reduction in the required storage capacity while suppressing an increase in the amount of computations in the transmission device 51 and the receiving device 52, thereby resulting in a reduction in the manufacturing cost of the device. Besides, power consumption is also reduced.

The communication system 5 may be adopted in various applications. The communication system 5 is applicable not only for communication using electromagnetic waves that propagate in the atmosphere or a vacuum, but also for communication that involves transmission and reception of high-frequency signals traveling through coaxial cables. The transmission device 51 and the receiving device 52, which are communication devices, may also adopt any of various other communication modes.

The Fourier transform device including rotators and memories that adopt the configuration shown in FIG. 5 (hereinafter, also referred to as the “Fourier transform device according to the present invention”, which includes an inverse Fourier transform device) is not limited to the FFT circuit 2 that adopts the architecture described in the above embodiment, and is also applicable as any Fourier transform device that performs a variety of Fourier transforms or inverse Fourier transforms. In the Fourier transform device, the number of combinations of rotators and rotation memories that adopt the configuration shown in FIG. 5 may be just one, or it may be two or more. The configuration shown in FIG. 5 enables reducing the storage capacity required to store twiddle factors while suppressing an increase in the amount of computations. That is, it is possible to achieve the securing of a sufficient bandwidth and the improvement in frequency resolution while reducing the required storage capacity. As a result, it is possible to reduce the manufacturing cost of the Fourier transform device.

In particular, in hardware FFT circuits that perform high-speed computations, there are limitations on the arrangement of readout lines from rotation memories and on the timing of readout. Therefore, it is not possible to reduce the storage capacity by sharing a rotation memory among rotators that have close computation timing. From this regard, it is effective in hardware FFT circuits to reduce the storage capacity via the configuration shown in FIG. 5.

In the case where the Fourier transform device includes a Radix-2^{k} circuit that performs computations using the Radix-2^{k} algorithm, there is only one rotator group (hereinafter, also referred to as the “general rotator group”) that needs to perform rotation operations using rotation angles that are integer multiples of 2π/N (i.e., each of 0 to (N−1) times). Therefore, by applying the rotators and the rotation memories shown in FIG. 5 to the general rotator group, it is possible to bring about a significant effect of reducing the required storage capacity. Although it depends on which part of the FFT circuit is considered as the Radix-2^{k} circuit, if the general rotator group with the configuration shown in FIG. 5 is considered as forming a part different from the Radix-2^{k} circuit (or the major part of the Radix-2^{k} circuit), the general rotator group is connected either upstream or downstream of the Radix-2^{k} circuit. If the FFT circuit as a whole is considered as the Radix-2^{k} circuit, the general rotator group with the configuration shown in FIG. 5 is included in the Radix-2^{k} circuit.

Note that the above expression of the “Radix-2^{k} circuit (or the major part of the Radix-2^{k} circuit)” is intended to mean that a circuit that characterizes the Radix-2^{k} algorithm is regarded as the Radix-2^{k} circuit. Thus, the Radix-2^{k} circuit corresponds to the part denoted by the reference signs 213 to 219 in the case shown in FIG. 2, the part denoted by the reference signs 232 to 235 in the case shown in FIG. 6, and the parts denoted by the reference signs 253 to 255 and the reference signs 257 to 259 in the case shown in FIG. 7. In other words, the Radix-2k circuit (or the major part of the Radix-2^{k} circuit) refers to an operation part where fixed rotation operations are performed using the Radix-2^{k} algorithm. In the case where computations are executed using the Radix-2^{k} algorithm, there is a constraint that N be a power of 2 greater than or equal to 2^{k}.

Moreover, in order to perform high-speed computations using the Radix-2^{k} circuit, it is preferable that the Fourier transform device is a multipath-delay-feedback type Fourier transform device as shown in FIGS. 2, 7, and 8. In general, in this Fourier transform device, multiple small Fourier transform circuits (small FFT circuits) are arranged in parallel on the input side. Each small Fourier transform circuit is a circuit that performs a single-input, single-output Fourier transform or a single-input, single-output inverse Fourier transform. The Radix-2^{k} circuit is arranged on the downstream side (output side) of the multiple small Fourier transform circuits. Then, the rotator group with the configuration shown in FIG. 5 is arranged between the multiple small Fourier transform circuits and the Radix-2^{k} circuit.

If the above-described circuit is expressed using P as the number of the aforementioned multiple small Fourier transform circuits, (P−1) rotators are arranged between the multiple small Fourier transform circuits and the Radix-2^{k} circuit, where P is 2 to the power of p, and p is an integer greater than or equal to 2. Here, p is the same value as k in the expression of “Radix-2^{k}”. If the above description is applied to the FFT circuit 2 shown in FIG. 2, 16 small Fourier transform circuits (small FFT circuits 221) are arranged in parallel, the Radix-2⁴ circuit is arranged downstream of the 16 small Fourier transform circuits, and 15 rotators (first rotators 222) are arranged between the 16 small Fourier transform circuits and the Radix-2⁴ circuit.

As is clear from a comparison between FIGS. 2 and 6, the smaller the above value p, the larger the storage capacity required of the parallel small Fourier transform circuits to store twiddle factors. Therefore, the greater the value k (i.e., the value p) in the Radix-2^{k} circuit, the more desirable it is to apply the configuration shown in FIG. 5. The value p is preferably greater than or equal to 4, more preferably greater than or equal to 5, and most preferably greater than or equal to 6.

Moreover, the small Fourier transform circuits may adopt the Radix-2^{k} circuit, or may adopt the configuration shown in FIG. 5.

Next, the reduction in the storage capacity required to store twiddle factor is described in more detail. Letting N be 2ⁿ, letting the number of first twiddle factors be 2ⁿ¹, and letting the number of second twiddle factors be 2ⁿ², where n, n1, and n2 are positive integers and satisfy n=n1+n2), if only the number of twiddle factors is considered, the number of twiddle factors can be reduced from 2ⁿ¹⁺ⁿ² to 2ⁿ¹+2ⁿ² by dividing each twiddle factor into the first and second twiddle factors.

For example, let the number of first twiddle factors be 2⁴ (=16), and let the number of second twiddle factors be 2⁴ (=16). If each twiddle factor is not separated, the number of twiddle factors would be 2⁸ (=256). Therefore, by separating each twiddle factor, the required storage capacity can be reduced by approximately 12% based on a simple calculation. Letting N be 2ₙ, where n is an even number greater than or equal to 6, letting the number of first twiddle factors be 2^{n/2}, and letting the number of second twiddle factors be 2^{n/2}, the number of twiddle factors is reduced from N to 2·N^{1/2}.

If the capacity required to store twiddle factors is considered as the number of real numbers and letting the number of first twiddle factors be 2ⁿ¹ and the number of second twiddle factors be 2ⁿ², then the number of real numbers is reduced from 2·2ⁿ¹⁺ⁿ² to 2·(2ⁿ¹+2ⁿ²). Here, considering the symmetry of sine and cosine functions, the numbers of real numbers to be stored as original twiddle factors and as the first twiddle factors can be reduced to one-eighth; therefore, the number of real numbers is reduced from 2ⁿ¹⁺ⁿ²⁻² (=2·2ⁿ¹⁺ⁿ²/8) to 2ⁿ¹⁻²+2·2ⁿ² (=2·(2ⁿ¹/8+2ⁿ²)). In the above example where N is 2¹⁷, letting n1=10 and n2=7, the number of real numbers to be stored is reduced from 2¹⁵ to 2⁹.

As described above, the number of real numbers that are actually stored as the first twiddle factors may be twice the number of first twiddle factors, or it may not be twice that number in consideration of the symmetry. In the above description, the expression of the “first rotation memory 43 stores the first twiddle factors” only means that the first twiddle factors are stored in a state that they can be read out quickly, and therefore the first rotation memory 43 does not necessarily have to store multiple first twiddle factors themselves.

From the perspective of reducing the required storage capacity, i.e., reducing circuit scale (including memory) to be implemented, it is preferable that n2 is greater than or equal to 3 and more preferably greater than or equal to 5. It is also preferable that n1 is greater than or equal to 3 and more preferably greater than or equal to 5. It is also preferable that n is greater than or equal to 10 and more preferably greater than or equal to 15. There is no need to define an upper limit for n, but from a technical standpoint, the upper limit for n is, for example, less than or equal to 30. The real numbers to be stored as the twiddle factors may be either floating points or fixed points, and may be either single-precision numbers or double-precision numbers.

Considering the symmetry of sine and cosine functions, the required storage capacity can be reduced by using a combination of n1 and n2 in which at least one of n1 and n2 is greater than that in a combination in which n1=3 and n2=1 (the number of first twiddle factors is 8 and the number of second twiddle factors is 2). That is, n1 is an integer greater than or equal to 3, n2 is an integer greater than or equal to 1, and n is an integer greater than or equal to 5.

Next, preferable performance of the Fourier transform device to which the present invention is applied is described. Conventional devices for performing Fourier transforms have, for example, a bandwidth of around 2 GHz and a frequency resolution of approximately 80 kHz. In contrast, the inventors have achieved a bandwidth of 4 GHz and a frequency resolution of 32 kHz by realizing the Fourier transform device including the FFT circuit 2 shown in FIG. 2. Specifically, the above performance has been achieved by operating the 16 parallel small FFT circuits 221 on a 300-MHz operation clock within FPGAs. This results in an improvement in performance by approximately four times that in conventional devices while reducing the required storage capacity.

In this way, it is preferable for the Fourier transform device according to the present invention to receive input of a digital signal resulting from digital conversion of an analog signal with a bandwidth of more than or equal to 4 GHz and to produce an output with a frequency resolution of less than or equal to 100 kHz. More preferably, the frequency resolution of the output is less than or equal to 50 kHz. In the case where the Fourier transform device performs inverse Fourier transforms, it is preferable that the frequency resolution in the input frequency information is less than or equal to 100 kHz and the bandwidth of the analog signal resulting from analog conversion of the output digital signal is more than or equal to 4 GHz. More preferably, the frequency resolution in the input frequency information is less than or equal to 50 kHz. In the case where the Fourier transform device according to the present invention is applied to a frequency analysis device, the frequency analysis device is preferably the one configured to perform frequency analysis on digital signals that are converted from high-frequency analog signals with frequencies of higher than or equal to 300 MHz and lower than or equal to 300 GHz.

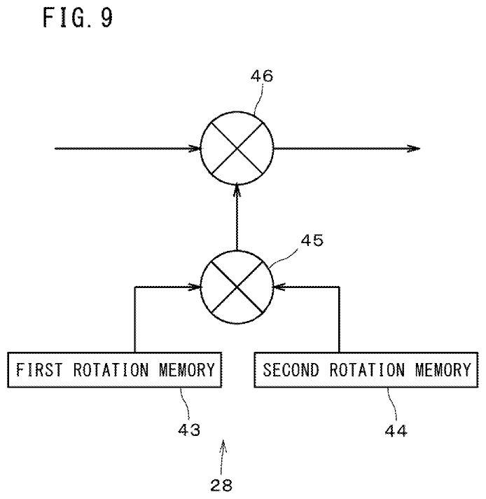

The configuration of the rotator (first rotator 222) (and the rotation memorie 28) shown in FIG. 5 may be modified in various ways as long as a rotation operation is performed using a rotation angle obtained by adding rotation angles indicated by first and second twiddle factors. For example, in FIG. 5, the position of a combination of the first complex multiplier 41 and the first rotation memory 43 may be swapped with the position of a combination of the second complex multiplier 42 and the second rotation memory 44. Moreover, a configuration as shown in FIG. 9 is possible in which a complex multiplier 45 is provided to receive input of a first twiddle factor, which is selected from the multiple first twiddle factors stored in the first rotation memory 43, and a second twiddle factor, which is selected from the multiple second twiddle factors stored in the second rotation memory 44, then the complex multiplier 45 obtains a synthesis twiddle factor that corresponds to a rotation angle obtained by adding rotation angles indicated by both of the twiddle factors, and then a complex multiplier 46 performs a rotation operation using the synthesis twiddle factor. That is, various configurations are available as the rotators and the rotation memories shown in FIG. 5 as long as the rotators and the rotation memories perform a rotation operation that combines a first twiddle factor selected from the multiple first twiddle factors and a second twiddle factor selected from the multiple second twiddle factors.

While one-dimensional Fourier transforms have been described in the above embodiment, the first twiddle factors corresponding to the coarse rotational positions and the second twiddle factors corresponding to the precise rotation angles interpolated in the coarse rotational positions, shown in FIG. 5, are also applicable to rotators and rotation memories that are used in two-dimensional or higher-dimensional Fourier transforms (including inverse Fourier transforms).

The configurations of the above-described preferred embodiment and variations may be appropriately combined as long as there are no mutual inconsistencies.

While the invention has been shown and described in detail, the foregoing description is in all aspects illustrative and not restrictive. It is therefore understood that numerous modifications and variations can be devised without departing from the scope of the invention.

### REFERENCE SIGNS LIST

12, 612, 622 Fourier transform device
28 rotation memory
41 first complex multiplier
42 second complex multiplier
43 first rotation memory
44 second rotation memory
45, 46 complex multiplier
51 transmission device
52 receiving device
211, 231, 251 small FFT circuit group
212, 232, 252 first rotator group
213, 233, 253 first butterfly operator group
214, 234, 254 second rotator group
215, 235, 255 second butterfly operator group
216, 256 third rotator group
217, 257 third butterfly operator group
218, 258 third rotator group
219, 259 third butterfly operator group
221, 241, 261 small FFT circuit (small Fourier transform circuit)
222, 242 first rotator
266 third rotator
513 D/A (digital-to-analog) converter
514, 525 antenna
523 A/D (analog-to-digital) converter

1. A Fourier transform device that performs either an N-point fast Fourier transform or an N-point inverse fast Fourier transform, where N is 2 to the power of n, and n is an integer greater than or equal to 5, the Fourier transform device comprising:
a rotator that performs a rotation operation; and
a rotation memory that stores twiddle factors,
wherein the rotation memory includes:
a first rotation memory storing a plurality of first twiddle factors that correspond to rotational positions resulting from dividing 2π into N1 equal parts, where N1 is an integer equal to 2 to the power of n1, and n1 is an integer greater than or equal to 3; and
a second rotation memory storing a plurality of second twiddle factors that correspond to rotational positions resulting from dividing 2π/N1 into N2 equal parts, N2 being N/N1, where N2 is an integer equal to 2 to the power of n2, and n2 is an integer greater than or equal to 1, and
said rotator performs a rotation operation that combines a first twiddle factor selected from said plurality of first twiddle factors and a second twiddle factor selected from said plurality of second twiddle factors.

2. The Fourier transform device according to claim 1, comprising:
a Radix-2^{k} circuit that performs a computation using a Radix-2^{k} algorithm,
wherein said rotator is either connected to or included in said Radix-2^{k} circuit.

3. The Fourier transform device according to claim 2, further comprising:
a plurality of small Fourier transform circuits aligned in parallel, the plurality of small Fourier transform circuits each being a circuit that performs either a single-input, single-output Fourier transform or a single-input, single-output inverse Fourier transform,
wherein said Radix-2^{k} circuit is arranged downstream of said plurality of small Fourier transform circuits, and
the Fourier transform device is a multipath delay feedback Fourier transform device in which a plurality of rotators including said rotator are arranged between said plurality of small Fourier transform circuits and said Radix-2^{k} circuit.

4. The Fourier transform device according to claim 3, wherein
the number of said plurality of small Fourier transform circuits is P, where P is 2 to the power of p, and p is an integer greater than or equal to 2, and
the Fourier transform device is a multipath delay feedback Fourier transform device in which (P−1) rotators including said rotator are arranged between said plurality of small Fourier transform circuits and said Radix-2^{k} circuit.

5. The Fourier transform device according to claim 2, further comprising:
16 small Fourier transform circuits aligned in parallel, the 16 small Fourier transform circuits each being a circuit that performs either a single-input, single-output Fourier transform or a single-input, single-output inverse Fourier transform,
wherein a Radix-2⁴ circuit serving as said Radix-2^{k} circuit is arranged downstream of said 16 small Fourier transform circuits, and
the Fourier transform device is a multipath delay feedback Fourier transform device in which 15 rotators including said rotator are arranged between said 16 small Fourier transform circuits and said Radix-2⁴ circuit.

6. The Fourier transform device according to claim 1,
the Fourier transform device receiving input of a digital signal resulting from digital conversion of an analog signal with a bandwidth of more than or equal to 4 GHz, and producing an output with a frequency resolution of less than or equal to 100 kHz, or the Fourier transform device receiving input of frequency information that includes a frequency resolution of less than or equal to 100 kHz, and producing an output that is an analog signal resulting from analog conversion of a digital signal and having a bandwidth of more than or equal to 4 GHz.

7. The Fourier transform device according to claim 6, wherein
said frequency resolution of said output is less than or equal to 50 kHz, or said frequency resolution included in said frequency information that is input is less than or equal to 50 kHz.

8. The Fourier transform device according to claim 1,
the Fourier transform device performing said fast Fourier transform in a device that performs frequency analysis on a digital signal resulting from conversion of a high-frequency analog signal at a frequency of higher than or equal to 300 MHz and lower than or equal to 300 GHz.

9. A wireless communication device comprising:
either an analog-to-digital converter or a digital-to-analog converter connected to an antenna; and
the Fourier transform device according to claim 1 that either performs a Fourier transform on a digital signal that is output from said analog-to-digital converter, or performs an inverse Fourier transform on digital information to transmit the digital information to said digital-to-analog converter.
